(19) United States
(12) Patent Application Publication
(10) Pub. No.: US 2016/0119986 A1
(43) Pub. Date: Apr. 28, 2016

(54) LIGHT-EMITTING DIODE DEVICE

(71) Applicant: FORMOSA PLASTICS CORPORATION, Kaohsiung City (TW)

(72) Inventors: Jimmy Liu, Kaohsiung City (TW); Chih-Ming Chen, Kaohsiung City (TW); Si-Fu Hsieh, Kaohsiung City (TW)

(73) Assignee: FORMOSA PLASTICS CORPORATION, Kaohsiung City (TW)

(21) Appl. No.: 14/919,345

(22) Filed: Oct. 21, 2015

(30) Foreign Application Priority Data
Oct. 23, 2014 (TW) 103136617

(51) Int. Cl. H05B 33/08

(52) U.S. Cl. CPC H05B 33/0815; H05B 33/0854

(57) ABSTRACT

A light-emitting diode (LED) device is capable of regulation of an operating current, and includes an LED unit configured to receive a direct current (DC) voltage for generating the operating current flowing therethrough, a regulating unit electrically connected to the LED unit, and a control unit electrically connected to the regulating unit. The regulating unit is configured to regulate the operating current so as to generate a limiting current flowing therethrough. The control unit is configured to control the regulating unit, according to one of the DC voltage and the limiting current, to generate the limiting current having a magnitude within a fixed range for regulating the operating current.

### CROSS-REFERENCE TO RELATED APPLICATION

This application claims priority of Taiwanese Application No. 103136617, filed on Oct. 23, 2014.

### FIELD

This disclosure relates to a light-emitting diode device, and more particularly to a light-emitting diode device capable of regulation of an operating current.

### BACKGROUND

A conventional light-emitting diode (LED) is commonly used for lighting, and has a relatively great luminous efficacy and low power consumption compared with an incandescent light bulb. The conventional LED is a semiconductor p-n junction diode consisting of a chip of semiconducting material doped with impurities to create a p-n junction, and thus, allows a flow of electricity in only one direction. Therefore, the conventional LED is generally driven by a direct current, and cannot be driven by an alternating current. The luminous intensity of the conventional LED is proportional directly to magnitude of an operating current flowing therethrough. Namely, the greater the magnitude of the operating current, the greater the luminous intensity of the conventional LED. Accordingly, it is important to regulate the operating current to make the conventional LED emit light having luminous intensity within a fixed range.

### SUMMARY

Therefore, an object of this disclosure is to provide a light-emitting diode device capable of regulation of an operating current.

According to this disclosure, a light-emitting diode (LED) device is capable of regulation of an operating current, and includes an LED unit, a regulating unit and a control unit.

The LED unit is configured to be electrically connected to a direct current (DC) voltage source, and to receive a DC voltage from the DC voltage source for generating the operating current flowing therethrough. The regulating unit is electrically connected to the LED unit, and is configured to regulate the operating current so as to generate a limiting current flowing therethrough. The control unit is electrically connected to the regulating unit, and is configured to control the regulating unit, according to one of the DC voltage and the limiting current, to generate the limiting current having a magnitude within a fixed range for regulating the operating current.

### BRIEF DESCRIPTION OF THE DRAWINGS

Other features and advantages of this disclosure will become apparent in the following detailed description of the embodiments with reference to the accompanying drawings, of which:

FIG. 1 is a block diagram of a first embodiment of a light-emitting diode (LED) device according to this disclosure;

FIG. 2 is a block diagram of a second embodiment of an LED device according to this disclosure;

FIG. 3 is a block diagram of a third embodiment of an LED device according to this disclosure;

FIG. 4 is a block diagram of a fourth embodiment of an LED device according to this disclosure;

FIG. 5 is a block diagram of a fifth embodiment of an LED device according to this disclosure; and

FIG. 6 is a block diagram of a sixth embodiment of an LED device according to this disclosure.

### DETAILED DESCRIPTION

Before the disclosure is described in greater detail, it should be noted that like elements are denoted by the same reference numerals throughout the disclosure.

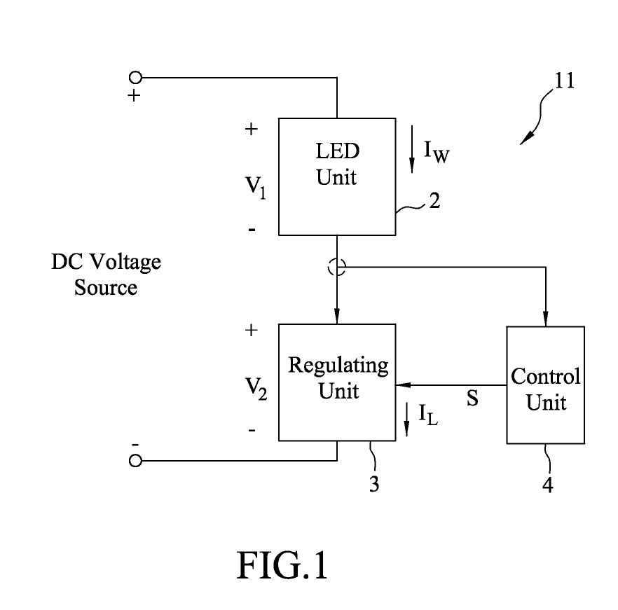

Referring to FIG. 1, a first embodiment of a light-emitting diode (LED) device 11 according to this disclosure includes an LED unit 2, a regulating unit 3 and a control unit 4. The LED device 11 is electrically connected to a direct current (DC) voltage source having electrically opposite first and second electrodes, and is capable of regulation of an operating current (I_{W}) flowing through the LED unit 2. For example, the first electrode is a positive electrode (+), and the second electrode is a negative electrode (−). The DC voltage source may be a DC power supply, or may include a rectifier for converting alternating current from an external power source into DC.

The LED unit 2 is electrically connected to the first electrode of the DC voltage source, and receives a DC voltage from the DC voltage source for generating the operating current (I_{W}) flowing therethrough. The LED unit 2 may include one or more LEDs that are electrically connected with one another in series, in parallel or in series-parallel.

The regulating unit 3 is electrically connected to the LED unit 2, and regulates the operating current (I_{W}) received from the LED unit 2 so as to generate a limiting current (I_{L}) flowing therethrough. Magnitude of the limiting current (I_{L}) is proportional directly to magnitude of the operating current (I_{W}). In this embodiment, the limiting current (I_{L}) is substantially equal to the operating current (I_{W}). The regulating unit 3 is, but not limited to, one of a variable resistor, a bipolar junction transistor (BJT), a metal-oxide-semiconductor field-effect transistor (MOSFET), and a combination thereof.

The control unit 4 is electrically connected to the regulating unit 3, and controls the regulating unit 3, according to the limiting current (I_{L}), to generate the limiting current (I_{L}) having the magnitude within a fixed range for regulating the operating current (I_{W}). In particular, the control unit 4 is configured to measure the limiting current (I_{L}) and to generate a control signal (S) according to a measured value of the limiting current (I_{L}), and the regulating unit 3 is configured to generate the limiting current (I_{L}) according to the control signal (S) from the control unit 4. The measured value is relative to the magnitude of the limiting current (I_{L}).

In this embodiment, the regulating unit 3 is a variable resistor having a first terminal, a second terminal and a control terminal. The first terminal is electrically connected to the LED unit 2 for receiving the operating current (I_{W}). The second terminal is electrically connected to the second electrode of the DC voltage source (i.e., the negative electrode (−)). The control terminal is electrically connected to the control unit 4 for receiving the control signal (S). The variable resistor is configured to adjust a resistance between the first and second terminals according to the control signal (S).

In operation, when the DC voltage from the DC voltage source is greater than a driving voltage, the LED unit 2 is conductive and is turned on, and generates the operating current (I_{W}) flowing therethrough. Accordingly, the regulating unit 3 receives the operating current (I_{W}) from the LED unit 2 so as to generate the limiting current (I_{L}), and the control unit 4 measures the limiting current (I_{L}) so as to generate the control signal (S). The control unit 4 compares the measured value of the limiting current (I_{L}) with a standard value, and generates the control signal (S) according to the comparison between the measured value of the limiting current (I_{L}) and the standard value. In particular, when the measured value is greater than the standard value, the control unit 4 generates the control signal (S) enabling the regulating unit 3 to increase the resistance thereof so as to decrease the limiting current (I_{L}), such that the operating current (I_{W}) is decreased at the same time. When the measured value is equal to the standard value, the control unit generates the control signal (S) enabling the regulating unit 3 to maintain the resistance so as to keep the limiting current (I_{L}) unchanged, such that the operating current (I_{W}) is unchanged at the same time. When the measured value is smaller than the standard value, the control unit 4 generates the control signal (S) enabling the regulating unit 3 to decrease the resistance so as to increase the limiting current (I_{L}), such that the operating current (I_{W}) is increased at the same time. As a result, the limiting current (I_{L}), as well as the operating current (I_{W}), is maintained within the fixed range, and thus, luminous intensity of the LED unit 2 is kept stable.

The driving voltage is the sum of a threshold voltage (V₁) for driving the LED unit 2 and a voltage (V₂) across the regulating unit 3. The standard value is pre-set by a user, and is relative to a current value within the fixed range.

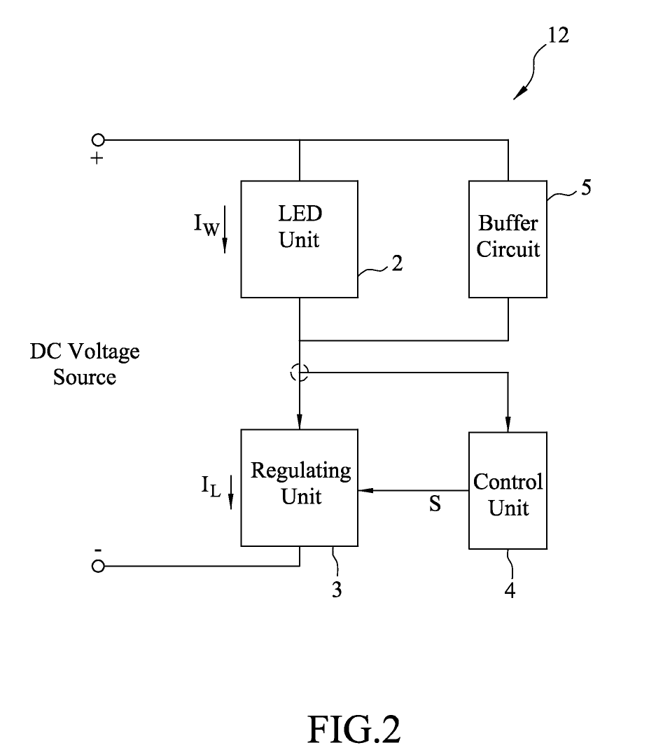

Referring to FIG. 2, a second embodiment of an LED device 12 according to this disclosure is shown to be similar to the first embodiment. In the second embodiment, the LED device 12 further includes a buffer circuit 5. The buffer circuit 5 is electrically connected to the LED unit 2 in parallel for receiving the DC voltage from the positive electrode (+) of the DC voltage source, and is configured to restrict the voltage across the LED unit 2. The buffer circuit 5 may consist of one of a capacitor, an inductor, and a combination thereof.

In this embodiment, the buffer circuit 5 consists of a capacitor. Since the buffer circuit 5 is electrically connected to the LED unit 2 in parallel, variation of the voltage across the LED unit 2 is divided and restricted by the buffer circuit 5. Accordingly, even if an instantaneous variation of the DC voltage is large, the buffer circuit 5 is useful for restricting the variation of the voltage across the LED unit 2.

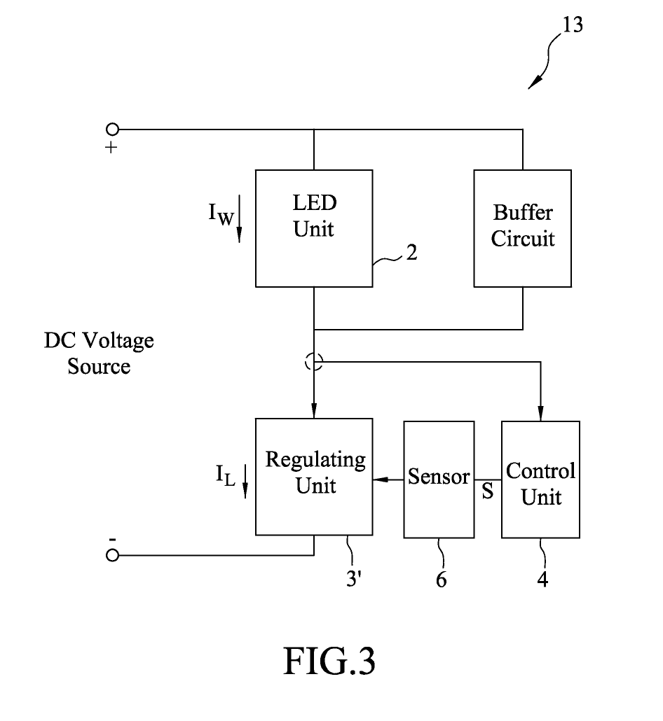

Referring to FIG. 3, a third embodiment of an LED device 13 according to this disclosure is shown to be similar to the second embodiment. In the third embodiment, the LED device 13 further includes a sensor 6. The sensor 6 is electrically connected between the regulating unit 3′ and the control unit 4, and is configured to measure an environment parameter and to adjust, according to the measurement of the environment parameter, a resistance thereof for controlling transmission of the control signal (S) from the control unit 4 to the regulating unit 3′. The sensor 6 may consist of a light-controlled variable resistor for measuring environment light, an infrared sensor for detecting presence of a person, and the like.

In this embodiment, the sensor 6 consists of a light-controlled variable resistor for measuring environment light intensity as the environment parameter, and the regulating unit 3′ is a transistor. The sensor 6 is configured to increase the resistance thereof with increase of the environment light intensity so as to restrict the transmission of the control signal (S). When detecting that the environment light intensity is great, the sensor 6 increases the resistance thereof to a significantly large value such that the control signal (S) cannot be completely transmitted to the regulating unit 3′. As a result, the regulating unit 3′ (i.e., the transistor) is in a cut-off operation region, and prevents a current from flowing therethrough. Namely, the regulating unit 3′ acts as an open switch, and thus, the LED unit 2 is inactive.

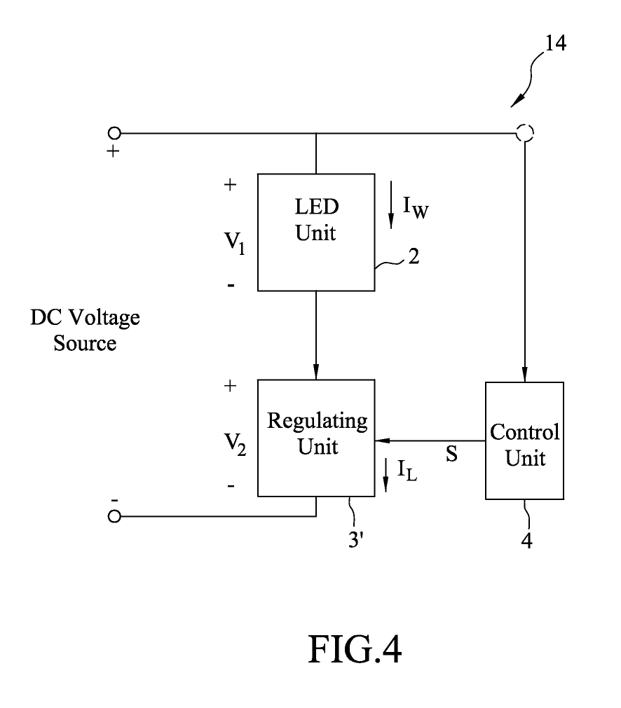

Referring to FIG. 4, a fourth embodiment of an LED device 14 according to this disclosure is shown to be similar to the first embodiment. In the fourth embodiment, the control unit 4 is electrically connected between the regulating unit 3′ and the positive electrode (+) of the DC voltage source. The control unit 4 of this embodiment is configured to measure the DC voltage from the DC voltage source, and to generate the control signal (S) according to a measured value of the DC voltage. The measured value is relative to the magnitude of the DC voltage.

In this embodiment, the regulating unit 3′ is a transistor having a first terminal electrically connected to the LED unit 2 for receiving the operating current (I_{W}), a second terminal electrically connected to the negative electrode (−) of the DC voltage source, and a control terminal electrically connected to the control unit 4 for receiving the control signal (S). In particular, the regulating unit 3′ is a MOSFET, the first terminal is a drain terminal of the MOSFET, the second terminal is a source terminal of the MOSFET, and the control terminal is a gate terminal of the MOSFET. The resistance between the drain terminal and the source terminal is variable according to the control signal (S).

Even though the regulating unit 3′ is implemented using the MOSFET, the detail operation thereof is similar to that of the regulation unit 3 of the first embodiment, which is a variable resistor. Thus, the detail operation of the regulating unit 3′ will be omitted herein for the sake of brevity.

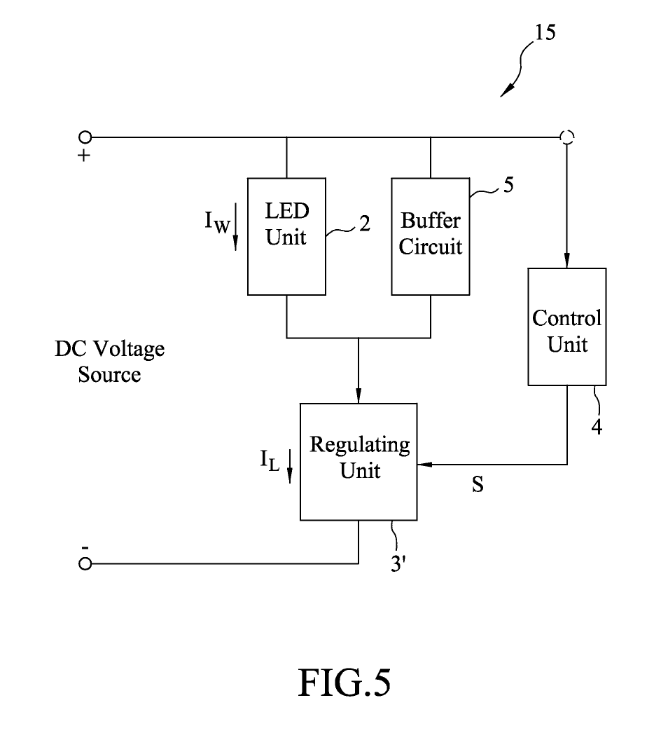

Referring to FIG. 5, a fifth embodiment of an LED device 15 according to this disclosure is shown to be similar to the fourth embodiment. In the fifth embodiment, the LED device 15 further includes the buffer circuit 5. The buffer circuit 5 is electrically connected to the LED unit 2 in parallel for receiving the DC voltage from the positive electrode (+) of the DC voltage source, and is configured to restrict the voltage across the LED unit 2.

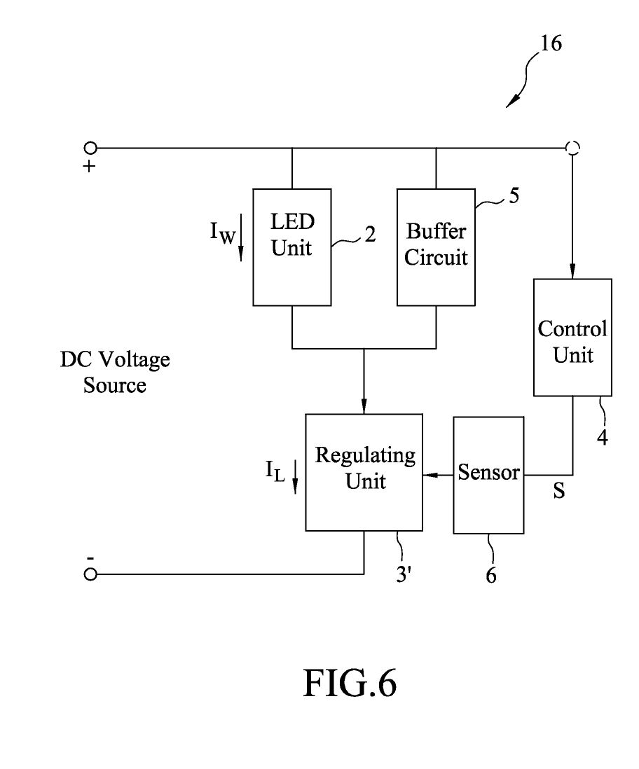

Referring to FIG. 6, a sixth embodiment of an LED device 16 according to this disclosure is shown to be similar to the fifth embodiment. In the sixth embodiment, the LED device 16 further includes the sensor 6. The sensor 6 is electrically connected between the regulating unit 3′ and the control unit 4, and is configured to measure the environment parameter and to adjust, according to the measurement of the environment parameter, the resistance thereof for controlling transmission of the control signal (S) from the control unit 4 to the regulating unit 3′.

In sum, the control unit 4 executes feedback control over the regulating unit 3, 3′ so as to regulate the limiting current (I_{L}), such that the magnitude of the limiting current (I_{L}) is within the fixed range and the operating current (I_{W}) is stable. Further, by virtue of the buffer circuit 5, the variation of the voltage across the LED unit 2 is restricted, such that the LED unit 2 is not subject to an abrupt variation of the DC voltage. Accordingly, the luminous intensity of the LED unit 2 is stable.

While this disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A light-emitting diode (LED) device capable of regulation of an operating current, said LED device comprising:
an LED unit configured to be electrically connected to a direct current (DC) voltage source and to receive a DC voltage from the DC voltage source for generating the operating current flowing therethrough;
a regulating unit electrically connected to said LED unit, and configured to regulate the operating current so as to generate a limiting current flowing therethrough; and
a control unit electrically connected to said regulating unit, and configured to control said regulating unit, according to one of the DC voltage and the limiting current, to generate the limiting current having a magnitude within a fixed range for regulating the operating current.

2. The LED device as claimed in claim 1, wherein said control unit is further configured to measure the limiting current and to generate a control signal according to a measured value of the limiting current, and said regulating unit is configured to generate the limiting current according to the control signal from said control unit.

3. The LED device as claimed in claim 2, wherein said control unit is further configured to:
compare the measured value of the limiting current with a standard value;
generate the control signal enabling said regulating unit to increase a resistance of said regulating unit so as to decrease the limiting current when the measured value is greater than the standard value;
generate the control signal enabling said regulating unit to maintain the resistance so as to keep the limiting current unchanged when the measured value is equal to the standard value; and
generate the control signal enabling said regulating unit to decrease the resistance so as to increase the limiting current when the measured value is smaller than the standard value.

4. The LED device as claimed in claim 2, wherein said LED unit is configured to be electrically connected to a first electrode of the DC voltage source,
wherein said regulating unit is a variable resistor having a first terminal electrically connected to said LED unit for receiving the operating current, a second terminal configured to be electrically connected to a second electrode of the DC voltage source electrically opposite to the first electrode, and a control terminal electrically connected to said control unit for receiving the control signal, and is configured to adjust a resistance between the first and second terminal according to the control signal.

5. The LED device as claimed in claim 2, wherein said LED unit is configured to be electrically connected to a first electrode of the DC voltage source,
wherein said regulating unit is a transistor having a first terminal electrically connected to said LED unit for receiving the operating current, a second terminal configured to be electrically connected to a second electrode of the DC voltage source electrically opposite to the first electrode, and a control terminal electrically connected to said control unit for receiving the control signal.

6. The LED device as claimed in claim 1, wherein said control unit is further configured to be electrically connected to the DC voltage source, to measure the DC voltage, and to generate a control signal according to a measured value of the DC voltage,
wherein said regulating unit is configured to generate the limiting current according to the control signal from said control unit.

7. The LED device as claimed in claim 6, wherein said control unit is further configured to:
compare the measured value of the DC voltage with a standard value;
generate the control signal enabling said regulating unit to increase a resistance of said regulating unit so as to decrease the limiting current when the measured value is greater than the standard value;
generate the control signal enabling said regulating unit to maintain the resistance so as to keep the limiting current unchanged when the measured value is equal to the standard value; and
generate the control signal enabling said regulating unit to decrease the resistance so as to increase the limiting current when the measured value is smaller than the standard value.

8. The LED device as claimed in claim 1, further comprising a buffer circuit electrically connected to said LED unit in parallel, and configured to restrict a voltage across said LED unit.

9. The LED device as claimed in claim 1, further comprising a sensor electrically connected between said regulating unit and said control unit, and configured to measure an environment parameter and to adjust, according to the measurement of the environment parameter, a resistance thereof for controlling transmission of the control signal from said control unit to said regulating unit.

10. The LED device as claimed in claim 9, wherein said sensor is a light-controlled variable resistor for measuring environment light intensity as the environment parameter, and is configured to increase the resistance thereof with increase of the environment light intensity so as to restrict the transmission of the control signal.
